(19) United States
(12) Patent Application Publication
(10) Pub. No.: US 2023/0377108 A1
(43) Pub. Date: Nov. 23, 2023

(54) INFORMATION PROCESSING APPARATUS, INFORMATION PROCESSING METHOD, AND PROGRAM

(71) Applicant: SONY SEMICONDUCTOR SOLUTIONS CORPORATION, KANAGAWA (JP)

(72) Inventor: SHUHEI HANAZAWA, KANAGAWA (JP)

(21) Appl. No.: 18/248,607

(22) PCT Filed: Oct. 8, 2021
(86) PCT No.: PCT/JP2021/037272

§ 371 Date: Apr. 11, 2023

(30) Foreign Application Priority Data
Oct. 23, 2020 (JP) 2020-178169

(51) Int. Cl. G06T 5/50; G06T 3/40

(52) U.S. Cl. CPC G06T 5/50; G06T 3/40; G06T 2207/20212; G06T 2207/30252

(57) ABSTRACT

The present technology relates to an information processing apparatus, an information processing method, and a program capable of easily generating an image on which haze is superimposed. The information processing apparatus includes a combining section that performs weighted addition of a pixel of a captured image and a pixel of a haze image representing a virtual haze by using a weight based on a depth value for each pixel of the captured image. The present technology can be applied to, for example, a system that generates an image for learning used for machine learning of a recognition model that performs object recognition in a moving body such as a vehicle.

### TECHNICAL FIELD

The present technology relates to an information processing apparatus, an information processing method, and a program, and more particularly, to an information processing apparatus, an information processing method, and a program capable of easily generating an image on which haze is superimposed.

### BACKGROUND ART

In recent years, in order to realize automated driving, research and development of technologies for performing object recognition around vehicles using recognition models obtained by machine learning and captured images obtained by capturing the periphery of the vehicles are active. In a recognition model using such a captured image, the accuracy of object recognition decreases under a situation where visibility is poor due to fog or mist.

In response to this, a technique for removing fog or mist from a captured image has been proposed (see, for example, Patent Document 1).

Furthermore, it is conceivable to improve the accuracy of object recognition even in a situation where visibility is poor due to fog or mist by performing machine learning using captured images captured in situations where visibility is poor due to fog or mist.

### CITATION LIST

### Patent Document

Patent Document 1: WO 2014/077126 A

### SUMMARY OF THE INVENTION

### Problems to be Solved by the Invention

However, since fog and mist are less frequently generated, it is difficult to collect a sufficient amount of learning images.

The present technology has been made in view of such a situation, and makes it possible to easily generate an image on which haze such as fog or mist is superimposed.

### Solutions to Problems

An information processing apparatus according to an aspect of the present technology includes a combining section that performs weighted addition of a pixel of a captured image and a pixel of a haze image representing a virtual haze by using a weight based on a depth value for each pixel of the captured image.

In an information processing method according to an aspect of the present technology, an information processing apparatus performs weighted addition of a pixel of a captured image and a pixel of a haze image representing a virtual haze by using a weight based on a depth value for each pixel of the captured image.

A program according to an aspect of the present technology causes a computer to execute processing of weighted addition of a pixel of a captured image and a pixel of a haze image representing a virtual haze by using a weight based on a depth value for each pixel of the captured image.

In an aspect of the present technology, weighted addition is performed on a pixel of a captured image and a pixel of a haze image representing a virtual haze by using a weight based on a depth value for each pixel of the captured image.

### BRIEF DESCRIPTION OF DRAWINGS

FIG. 1 is a block diagram illustrating a configuration example of a vehicle control system.

FIG. 2 is a diagram illustrating an example of sensing areas.

FIG. 3 is a block diagram illustrating a configuration example of an information processing system to which the present technology is applied.

FIG. 4 is a flowchart for explaining haze superimposition processing.

FIG. 5 is a diagram illustrating an example of a captured image and a depth image.

FIG. 6 is a diagram illustrating an example of a captured image and a template image.

FIG. 7 is a diagram illustrating an example of a captured image and a template image.

FIG. 8 is a diagram for explaining a method of generating a template image.

FIG. 9 is a diagram for explaining a method of generating a template image.

FIG. 10 is a diagram illustrating an example of a combined depth image.

FIG. 11 is a diagram illustrating an example of a haze image.

FIG. 12 is a diagram illustrating an example of a haze superimposed image.

FIG. 13 is a block diagram illustrating a configuration example of a computer.

### MODE FOR CARRYING OUT THE INVENTION

Hereinafter, modes for carrying out the present technology will be described. The description will be given in the following order.

1. Configuration Example of Vehicle Control System

2. Embodiments

3. Modifications

4. Others

### 1. CONFIGURATION EXAMPLE OF VEHICLE CONTROL SYSTEM

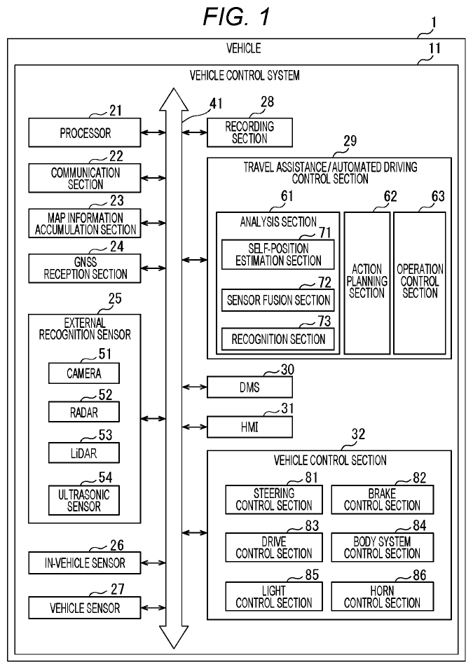

FIG. 1 is a block diagram illustrating a configuration example of a vehicle control system 11 which is an example of a moving apparatus control system to which the present technology is applied.

The vehicle control system 11 is provided in a vehicle 1 and performs processing related to travel assistance and automated driving of the vehicle 1.

The vehicle control system 11 includes a processor 21, a communication section 22, a map information accumulation section 23, a global navigation satellite system (GNSS) reception section 24, an external recognition sensor 25, an in-vehicle sensor 26, a vehicle sensor 27, a recording section 28, a travel assistance/automated driving control section 29, a driver monitoring system (DMS) 30, a human machine interface (HMI) 31, and a vehicle control section 32.

The processor 21, the communication section 22, the map information accumulation section 23, the GNSS reception section 24, the external recognition sensor 25, the in-vehicle sensor 26, the vehicle sensor 27, the recording section 28, the travel assistance/automated driving control section 29, the driver monitoring system (DMS) 30, the human machine interface (HMI) 31, and the vehicle control section 32 are connected to one another via a communication network 41. The communication network 41 includes, for example, an in-vehicle communication network, a bus, or the like conforming to an arbitrary standard such as a controller area network (CAN), a local interconnect network (LIN), a local area network (LAN), FlexRay (registered trademark), Ethernet, or the like. Note that each section of the vehicle control system 11 may be directly connected by, for example, near field communication (NFC), Bluetooth (registered trademark), or the like without passing through the communication network 41.

Note that, hereinafter, in a case where each section of the vehicle control system 11 performs communication via the communication network 41, description of the communication network 41 will be omitted. For example, in a case where the processor 21 and the communication section 22 perform communication via the communication network 41, it is simply described that the processor 21 and the communication section 22 perform communication.

The processor 21 includes various processors such as a central processing unit (CPU), a micro processing unit (MPU), an electronic control unit (ECU), or the like, for example. The processor 21 controls the entire vehicle control system 11.

The communication section 22 communicates with various devices inside and outside the vehicle, other vehicles, servers, base stations, and the like, and transmits and receives various data. As the communication with the outside of the vehicle, for example, the communication section 22 receives a program for updating software for controlling the operation of the vehicle control system 11, map information, traffic information, information around the vehicle 1, and the like from the outside. For example, the communication section 22 transmits information regarding the vehicle 1 (for example, data indicating the state of the vehicle 1, a recognition result by the recognition section 73, and the like), information around the vehicle 1, and the like to the outside. For example, the communication section 22 performs communication corresponding to a vehicle emergency call system such as an eCall or the like.

Note that a communication method of the communication section 22 is not particularly limited. Furthermore, a plurality of communication methods may be used.

As communication with the inside of the vehicle, for example, the communication section 22 performs wireless communication with a device in the vehicle by a communication method such as wireless LAN, Bluetooth, NFC, wireless USB (WUSB), or the like. For example, the communication section 22 performs wired communication with a device in the vehicle by a communication method such as a universal serial bus (USB), a high-definition multimedia interface (HDMI, registered trademark), a mobile high-definition link (MHL), or the like via a connection terminal (and, if necessary, a cable) not illustrated.

Here, the in-vehicle device is, for example, a device that is not connected to the communication network 41 in the vehicle. For example, a mobile device or a wearable device carried by an occupant such as a driver or the like, an information device brought into the vehicle and temporarily installed, or the like is assumed.

For example, the communication section 22 communicates with a server or the like present on an external network (for example, the Internet, a cloud network, or a company-specific network) via a base station or an access point by a wireless communication method such as fourth generation mobile communication system (4G), fifth generation mobile communication system (5G), long term evolution (LTE), dedicated short range communications (DSRC), or the like.

For example, the communication section 22 communicates with a terminal (for example, a terminal of a pedestrian or a store, or a machine type communication (MTC) terminal) present in the vicinity of the host vehicle using a peer to peer (P2P) technology. For example, the communication section 22 performs V2X communication. The V2X communication is, for example, vehicle to vehicle communication with another vehicle, vehicle to infrastructure communication with a roadside device or the like, vehicle to home communication, vehicle to pedestrian communication with a terminal or the like possessed by a pedestrian, or the like.

For example, the communication section 22 receives an electromagnetic wave transmitted by a road traffic information communication system (vehicle information and communication system (VICS), registered trademark) such as a radio wave beacon, an optical beacon, FM multiplex broadcasting, or the like.

The map information accumulation section 23 accumulates a map acquired from the outside and a map created by the vehicle 1. For example, the map information accumulation section 23 accumulates a three-dimensional high-precision map, a global map having lower accuracy than the highly accurate map but covering a wide area, and the like.

The high-precision map is, for example, a dynamic map, a point cloud map, a vector map (also referred to as an advanced driver assistance system (ADAS) map), or the like. The dynamic map is, for example, a map including four layers of dynamic information, semi-dynamic information, semi-static information, and static information, and is provided from an external server or the like. The point cloud map is a map including point clouds (point cloud data). The vector map is a map in which information such as a lane, a position of a signal, and the like is associated with the point cloud map. The point cloud map and the vector map may be provided from, for example, an external server or the like, or may be created by the vehicle 1 as a map for performing matching with a local map to be described later on the basis of a sensing result by a radar 52, a LiDAR 53, or the like, and may be accumulated in the map information accumulation section 23. Furthermore, in a case where a high-precision map is provided from an external server or the like, for example, map data of several hundred meters square regarding a planned route on which the vehicle 1 travels from now is acquired from the server or the like in order to reduce the communication capacity.

The GNSS reception section 24 receives a GNSS signal from a GNSS satellite, and supplies the GNSS signal to the travel assistance/automated driving control section 29.

The external recognition sensor 25 includes various sensors used for recognizing a situation outside the vehicle 1, and supplies sensor data from each sensor to each section of the vehicle control system 11. The type and number of sensors included in the external recognition sensor 25 are arbitrary.

For example, the external recognition sensor 25 includes a camera 51, a radar 52, a light detection and ranging or laser imaging detection and ranging (LiDAR) 53, and an ultrasonic sensor 54. The number of the cameras 51, the radars 52, the LiDARs 53, and the ultrasonic sensors 54 is arbitrary, and an example of a sensing area of each sensor will be described later.

Note that, as the camera 51, for example, a camera of an arbitrary imaging method such as a time of flight (ToF) camera, a stereo camera, a monocular camera, an infrared camera, or the like is used as necessary.

Furthermore, for example, the external recognition sensor 25 includes an environment sensor for detecting weather, climate, brightness, and the like. The environment sensor includes, for example, a raindrop sensor, a fog sensor, a sunshine sensor, a snow sensor, an illuminance sensor, and the like.

Moreover, for example, the external recognition sensor 25 includes a microphone used for detecting a sound around the vehicle 1, a position of a sound source, and the like.

The in-vehicle sensor 26 includes various sensors for detecting information inside the vehicle, and supplies sensor data from each sensor to each section of the vehicle control system 11. The type and number of sensors included in the in-vehicle sensor 26 are arbitrary.

For example, the in-vehicle sensor 26 includes a camera, a radar, a seating sensor, a steering wheel sensor, a microphone, a biometric sensor, and the like. As the camera, for example, a camera of any imaging method such as a ToF camera, a stereo camera, a monocular camera, an infrared camera, or the like can be used. The biometric sensor is provided, for example, on a seat, a steering wheel, or the like, and detects various types of biometric information of an occupant such as a driver and the like.

The vehicle sensor 27 includes various sensors for detecting the state of the vehicle 1, and supplies sensor data from each sensor to each section of the vehicle control system 11. The type and number of sensors included in the vehicle sensor 27 are arbitrary.

For example, the vehicle sensor 27 includes a speed sensor, an acceleration sensor, an angular velocity sensor (gyro sensor), and an inertial measurement unit (IMU). For example, the vehicle sensor 27 includes a steering angle sensor that detects a steering angle of a steering wheel, a yaw rate sensor, an accelerator sensor that detects an operation amount of an accelerator pedal, and a brake sensor that detects an operation amount of a brake pedal. For example, the vehicle sensor 27 includes a rotation sensor that detects the number of rotations of the engine or the motor, an air pressure sensor that detects the air pressure of the tire, a slip rate sensor that detects the slip rate of the tire, and a wheel speed sensor that detects the rotation speed of the wheel. For example, the vehicle sensor 27 includes a battery sensor that detects the remaining amount and temperature of the battery, and an impact sensor that detects an external impact.

The recording section 28 includes, for example, a read only memory (ROM), a random access memory (RAM), a magnetic storage device such as a hard disc drive (HDD) or the like, a semiconductor storage device, an optical storage device, a magneto-optical storage device, and the like. The recording section 28 records various programs, data, and the like used by each section of the vehicle control system 11. For example, the recording section 28 records a rosbag file including a message transmitted and received by a robot operating system (ROS) in which an application program related to automated driving operates. For example, the recording section 28 includes an event data recorder (EDR) and a data storage system for automated driving (DSSAD), and records information of the vehicle 1 before and after an event such as an accident or the like.

The travel assistance/automated driving control section 29 controls travel assistance and automated driving of the vehicle 1. For example, the travel assistance/automated driving control section 29 includes an analysis section 61, an action planning section 62, and an operation control section 63.

The analysis section 61 performs analysis processing of the situation of the vehicle 1 and the surroundings. The analysis section 61 includes a self-position estimation section 71, a sensor fusion section 72, and a recognition section 73.

The self-position estimation section 71 estimates the self-position of the vehicle 1 on the basis of the sensor data from the external recognition sensor 25 and the high-precision map accumulated in the map information accumulation section 23. For example, the self-position estimation section 71 generates a local map on the basis of sensor data from the external recognition sensor 25, and estimates the self-position of the vehicle 1 by matching the local map with the high-precision map. The position of the vehicle 1 is based on, for example, the center of the rear wheel pair axle.

The local map is, for example, a three-dimensional high-precision map created using a technology such as simultaneous localization and mapping (SLAM), or the like, an occupancy grid map, or the like. The three-dimensional high-precision map is, for example, the above-described point cloud map or the like. The occupancy grid map is a map in which a three-dimensional or two-dimensional space around the vehicle 1 is divided into grids of a predetermined size, and an occupancy state of an object is indicated in units of grids. The occupancy state of the object is indicated by, for example, the presence or absence or existence probability of the object. The local map is also used for detection processing and recognition processing of a situation outside the vehicle 1 by the recognition section 73, for example.

Note that the self-position estimation section 71 may estimate the self-position of the vehicle 1 on the basis of the GNSS signal and the sensor data from the vehicle sensor 27.

The sensor fusion section 72 performs sensor fusion processing of combining a plurality of different types of sensor data (for example, image data supplied from the camera 51 and sensor data supplied from the radar 52) to obtain new information. Methods for combining different types of sensor data include integration, fusion, association, and the like.

The recognition section 73 performs detection processing and recognition processing of a situation outside the vehicle 1.

For example, the recognition section 73 performs detection processing and recognition processing of a situation outside the vehicle 1 on the basis of information from the external recognition sensor 25, information from the self-position estimation section 71, information from the sensor fusion section 72, and the like.

Specifically, for example, the recognition section 73 performs detection processing, recognition processing, and the like of an object around the vehicle 1. The object detection processing is, for example, processing of detecting the presence or absence, size, shape, position, movement, and the like of an object. The object recognition processing is, for example, processing of recognizing an attribute such as a type of an object or the like or identifying a specific object. However, the detection processing and the recognition processing are not necessarily clearly divided, and may overlap.

For example, the recognition section 73 detects an object around the vehicle 1 by performing clustering for classifying point clouds based on sensor data such as LiDAR, radar, or the like for each cluster of point clouds. As a result, the presence or absence, size, shape, and position of an object around the vehicle 1 are detected.

For example, the recognition section 73 detects the motion of the object around the vehicle 1 by performing tracking that follows the motion of the cluster of the point cloud classified by clustering. As a result, the speed and the traveling direction (movement vector) of the object around the vehicle 1 are detected.

For example, the recognition section 73 recognizes the type of the object around the vehicle 1 by performing object recognition processing such as semantic segmentation or the like on the image data supplied from the camera 51.

Note that, as the object to be detected or recognized, for example, a vehicle, a person, a bicycle, an obstacle, a structure, a road, a traffic light, a traffic sign, a road sign, and the like are assumed.

For example, the recognition section 73 performs recognition processing of traffic rules around the vehicle 1 on the basis of the map accumulated in the map information accumulation section 23, the estimation result of the self-position, and the recognition result of the object around the vehicle 1. By this processing, for example, the position and the state of the signal, the contents of the traffic sign and the road sign, the contents of the traffic regulation, the travelable lane, and the like are recognized.

For example, the recognition section 73 performs recognition processing of the environment around the vehicle 1. As the surrounding environment to be recognized, for example, weather, temperature, humidity, brightness, a state of a road surface, and the like are assumed.

The action planning section 62 creates an action plan of the vehicle 1. For example, the action planning section 62 creates an action plan by performing processing of route planning and route following.

Note that the route planning (global path planning) is a process of planning a rough route from the start to the goal. This route planning is called a track planning, and includes processing of track generation (local path planning) that enables safe and smooth traveling in the vicinity of the vehicle 1 in consideration of the motion characteristics of the vehicle 1 in the route planned by the route planning.

Route following is a process of planning an operation for safely and accurately traveling a route planned by route planning within a planned time. For example, the target speed and the target angular velocity of the vehicle 1 are calculated. The operation control section 63 controls the operation of the vehicle 1 in order to implement the action plan created by the action planning section 62.

For example, the operation control section 63 controls a steering control section 81, a brake control section 82, and a drive control section 83 to perform acceleration/deceleration control and direction control such that the vehicle 1 travels on the track calculated by the track planning. For example, the operation control section 63 performs cooperative control for the purpose of implementing the functions of the ADAS such as collision avoidance or impact mitigation, follow-up traveling, vehicle speed maintaining traveling, collision warning of the host vehicle, lane deviation warning of the host vehicle, and the like. For example, the operation control section 63 performs cooperative control for the purpose of automated driving or the like in which the vehicle automatedly travels without depending on the operation of the driver.

The DMS 30 performs a driver authentication processing, a driver state recognition processing, and the like on the basis of sensor data from the in-vehicle sensor 26, input data input to the HMI 31, and the like. As the state of the driver to be recognized, for example, a physical condition, a wakefulness level, a concentration level, a fatigue level, a line-of-sight direction, a drunkenness level, a driving operation, a posture, and the like are assumed.

Note that the DMS 30 may perform authentication processing of an occupant other than the driver and recognition processing of the state of the occupant. Furthermore, for example, the DMS 30 may perform recognition processing of the situation inside the vehicle on the basis of sensor data from the in-vehicle sensor 26. As the situation inside the vehicle to be recognized, for example, temperature, humidity, brightness, odor, and the like are assumed.

The HMI 31 is used for inputting various data, instructions, and the like, generates a signal input on the basis of the input data, instructions, and the like, and supplies the input signal to each section of the vehicle control system 11. For example, the HMI 31 includes an operation device such as a touch panel, a button, a microphone, a switch, a lever, and the like, an operation device that can input by a method other than manual operation such as voice, gesture, or the like, and the like. Note that the HMI 31 may be, for example, a remote control device using infrared rays or other radio waves, or an external connection device such as a mobile device, a wearable device, or the like compatible with the operation of the vehicle control system 11.

Furthermore, the HMI 31 performs output control to control generation and output of visual information, auditory information, and tactile information on the occupant or the outside of the vehicle, output content, output timing, an output method, and the like. The visual information is, for example, information indicated by an image or light such as an operation screen, a state display of the vehicle 1, a warning display, a monitor image indicating a situation around the vehicle 1, or the like. The auditory information is, for example, information indicated by sound such as guidance, a warning sound, a warning message, or the like. The tactile information is, for example, information given to the tactile sense of the occupant by force, vibration, motion, or the like.

As a device that outputs visual information, for example, a display device, a projector, a navigation device, an instrument panel, a camera monitoring system (CMS), an electronic mirror, a lamp, and the like are assumed. The display device may be, for example, a device that displays visual information in the field of view of the occupant, such as a head-up display, a transmissive display, a wearable device having an augmented reality (AR) function, or the like, in addition to a device having a normal display.

As a device that outputs auditory information, for example, an audio speaker, a headphone, an earphone, or the like is assumed.

As a device that outputs tactile information, for example, a haptics element using haptics technology or the like is assumed. The haptics element is provided, for example, on a steering wheel, a seat, or the like.

The vehicle control section 32 controls each section of the vehicle 1. The vehicle control section 32 includes a steering control section 81, a brake control section 82, a drive control section 83, a body system control section 84, a light control section 85, and a horn control section 86.

The steering control section 81 detects and controls the state of the steering system of the vehicle 1 or the like. The steering system includes, for example, a steering mechanism including a steering wheel and the like, an electric power steering, and the like. The steering control section 81 includes, for example, a control unit such as an ECU or the like that controls the steering system, an actuator that drives the steering system, and the like.

The brake control section 82 detects and controls the state of the brake system of the vehicle 1 or the like. The brake system includes, for example, a brake mechanism including a brake pedal, an antilock brake system (ABS), and the like. The brake control section 82 includes, for example, a control unit such as an ECU or the like that controls a brake system, an actuator that drives the brake system, and the like.

The drive control section 83 detects and controls the state of the drive system of the vehicle 1 or the like. The drive system includes, for example, a driving force generation device for generating a driving force such as an accelerator pedal, an internal combustion engine, a driving motor, or the like, a driving force transmission mechanism for transmitting the driving force to wheels, and the like. The drive control section 83 includes, for example, a control unit such as an ECU or the like that controls the drive system, an actuator that drives the drive system, and the like.

The body system control section 84 detects and controls the state of the body system of the vehicle 1 or the like. The body system includes, for example, a keyless entry system, a smart key system, a power window device, a power seat, an air conditioner, an airbag, a seat belt, a shift lever, and the like. The body system control section 84 includes, for example, a control unit such as an ECU or the like that controls the body system, an actuator that drives the body system, and the like.

The light control section 85 detects and controls states of various lights of the vehicle 1 or the like. As the light to be controlled, for example, a headlight, a backlight, a fog light, a turn signal, a brake light, a projection, a display of a bumper, and the like are assumed. The light control section 85 includes a control unit such as an ECU or the like that controls light, an actuator that drives light, and the like.

The horn control section 86 detects and controls the state of the car horn of the vehicle 1 or the like. The horn control section 86 includes, for example, a control unit such as an ECU or the like that controls the car horn, an actuator that drives the car horn, and the like.

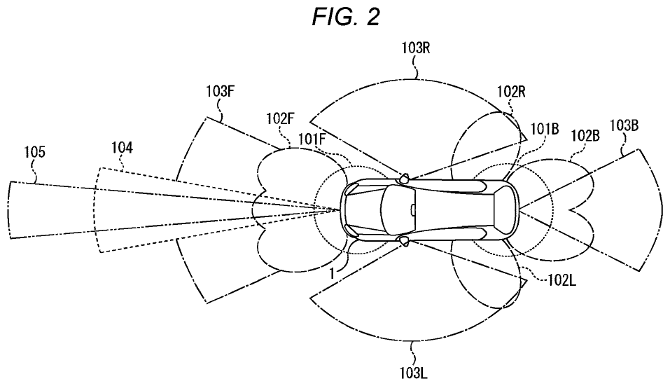

FIG. 2 is a diagram illustrating an example of sensing areas by the camera 51, the radar 52, the LiDAR 53, and the ultrasonic sensor 54 of the external recognition sensor 25 in FIG. 1.

The sensing area 101F and the sensing area 101B illustrate examples of sensing areas of the ultrasonic sensor 54. The sensing area 101F covers the periphery of the front end of the vehicle 1. The sensing area 101B covers the periphery of the rear end of the vehicle 1.

The sensing results in the sensing area 101F and the sensing area 101B are used, for example, for parking assistance of the vehicle 1 or the like.

The sensing areas 102F to 102B illustrate examples of sensing areas of the radar 52 for a short distance or a middle distance. The sensing area 102F covers a position farther than the sensing area 101F in front of the vehicle 1. The sensing area 102B covers a position farther than the sensing area 101B behind the vehicle 1. The sensing area 102L covers the rear periphery of the left side surface of the vehicle 1. The sensing area 102R covers the rear periphery of the right side surface of the vehicle 1.

The sensing result in the sensing area 102F is used, for example, to detect a vehicle, a pedestrian, or the like present in front of the vehicle 1. The sensing result in the sensing area 102B is used, for example, for a collision prevention function or the like behind the vehicle 1. The sensing results in the sensing area 102L and the sensing area 102R are used, for example, for detecting an object in a blind spot on the sides of the vehicle 1 or the like.

The sensing areas 103F to 103B illustrate examples of sensing areas by the camera 51. The sensing area 103F covers a position farther than the sensing area 102F in front of the vehicle 1. The sensing area 103B covers a position farther than the sensing area 102B behind the vehicle 1. The sensing area 103L covers the periphery of the left side surface of the vehicle 1. The sensing area 103R covers the periphery of the right side surface of the vehicle 1.

The sensing result in the sensing area 103F is used for, for example, recognition of a traffic light or a traffic sign, a lane departure prevention assist system, and the like. The sensing result in the sensing area 103B is used for, for example, parking assistance, a surround view system, and the like. The sensing results in the sensing area 103L and the sensing area 103R are used, for example, in a surround view system or the like.

The sensing area 104 illustrates an example of a sensing area of the LiDAR 53. The sensing area 104 covers a position farther than the sensing area 103F in front of the vehicle 1. Meanwhile, the sensing area 104 has a narrower range in the left-right direction than the sensing area 103F.

The sensing result in the sensing area 104 is used for, for example, emergency braking, collision avoidance, pedestrian detection, and the like.

The sensing area 105 illustrates an example of a sensing area of the long-range radar 52. The sensing area 105 covers a position farther than the sensing area 104 in front of the vehicle 1. Meanwhile, the sensing area 105 has a narrower range in the left-right direction than the sensing area 104.

The sensing result in the sensing area 105 is used for, for example, adaptive cruise control (ACC) or the like.

Note that the sensing area of each sensor may have various configurations other than those in FIG. 2. Specifically, the ultrasonic sensor 54 may also sense the sides of the vehicle 1, or the LiDAR 53 may sense the rear of the vehicle 1.

### 2. EMBODIMENTS

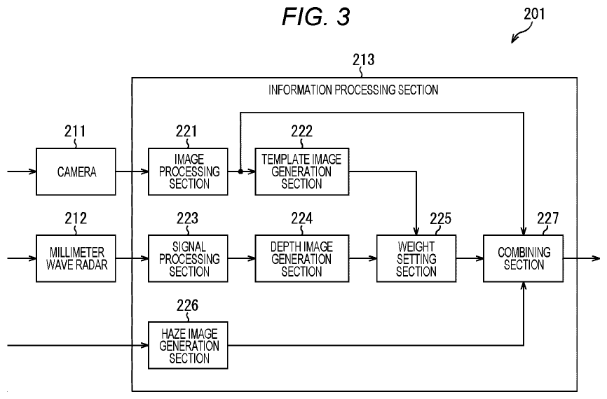

Next, embodiments of the present technology will be described with reference to FIGS. 3 to 12.

<Configuration Example of Information Processing System 201>

FIG. 3 illustrates a configuration example of an information processing system 201 to which the present technology is applied.

The information processing system 201 is used for the recognition section 73 of the vehicle 1, for example, and generates an image (hereinafter, referred to as a learning image) used for machine learning of a recognition model that performs object recognition. In particular, the information processing system 201 generates an image (hereinafter, referred to as a haze superimposed image) in which the virtual haze is superimposed on the captured image captured by the camera 211 among learning images.

Here, the haze is a phenomenon in which water vapor or fine particles float in the atmosphere and visibility is hindered. Haze originating from water vapor includes, for example, fog, mist, and the like. The fine particles serving as a source of haze are not particularly limited, and include, for example, dust, smoke, soot, dust, sand, ash, and the like.

The information processing system 201 includes a camera 211, a millimeter wave radar 212, and an information processing section 213.

The camera 211 includes, for example, a camera that captures an image in front of the vehicle 1 among the cameras 51 of the vehicle 1. The camera 211 supplies a captured image obtained by capturing the front of the vehicle 1 to an image processing section 221 of the information processing section 213.

The millimeter wave radar 212 includes, for example, a millimeter wave radar that performs sensing in front of the vehicle 1 among the radars 52 of the vehicle 1. For example, the millimeter wave radar 202 transmits a transmission signal including a millimeter wave to the front of the vehicle 1, and receives a reception signal which is a signal reflected by an object (reflector) in front of the vehicle 1 by a reception antenna. For example, a plurality of reception antennas is provided at predetermined intervals in the lateral direction (width direction) of the vehicle 1. Furthermore, a plurality of reception antennas may also be provided in the height direction. The millimeter wave radar 212 supplies data (hereinafter, referred to as millimeter wave data) indicating the strength of the reception signal received by each reception antenna in time series to a signal processing section 223 of the information processing section 213.

Note that it is desirable that the imaging range of the camera 211 and the sensing range of the millimeter wave radar 212 at least partially overlap, and the overlapping range becomes larger.

The information processing section 213 generates a haze superimposed image in which a virtual haze is superimposed on the captured image on the basis of the captured image and the millimeter wave data. The information processing section 213 includes the image processing section 221, a template image generation section 222, the signal processing section 223, a depth image generation section 224, a weight setting section 225, a haze image generation section 226, and a combining section 227.

The image processing section 221 performs predetermined image processing on the captured image. For example, the image processing section 221 extracts an image of a region corresponding to the sensing range of the millimeter wave radar 212 from the captured image and performs filtering processing. The image processing section 221 supplies the captured image after the image processing to the template image generation section 222 and the combining section 227.

The template image generation section 222 generates a template image representing a pattern corresponding to the shading of the haze on the basis of the captured image. The template image generation section 222 supplies the template image to the weight setting section 225.

The signal processing section 223 performs predetermined signal processing on the millimeter wave data to generate a sensing image that is an image indicating a sensing result of the millimeter wave radar 212. For example, the signal processing section 223 generates a sensing image indicating the position of each object in front of the vehicle 1 and the strength of the signal (reception signal) reflected by each object. The signal processing section 223 supplies the sensing image to the depth image generation section 224.

The depth image generation section 224 converts the sensing image into an image in the same coordinate system as the captured image by performing geometric conversion of the sensing image. In other words, the depth image generation section 224 converts the sensing image into an image viewed from the same viewpoint as the captured image. The depth value, which is a pixel value of each pixel of the depth image, indicates a distance to an object in front of the vehicle 1 at a position corresponding to each pixel. The depth image generation section 224 supplies the depth image to the weight setting section 225.

The weight setting section 225 sets a weight for each pixel of the captured image on the basis of the template image and the depth image. Specifically, the weight setting section 225 generates an image (hereinafter, referred to as a mask image) having a weight for each pixel of the captured image as a pixel value on the basis of the template image and the depth image. The weight setting section 225 supplies the mask image to the combining section 227.

The haze image generation section 226 generates a haze image representing a virtual haze to be superimposed on the captured image. The haze image generation section 226 supplies the haze image to the combining section 227.

The combining section 227 generates a haze superimposed image in which a virtual haze is superimposed on the captured image by combining the captured image and the haze image on the basis of the mask image. Specifically, the combining section 227 generates the haze superimposed image by performing weighted addition on each pixel of the captured image and each pixel of the haze image by using a weight for each pixel indicated by the mask image. The combining section 227 outputs the haze superimposed image to the subsequent stage.

Note that the information processing section 213 may be provided in the vehicle 1 or may be provided separately from the vehicle 1. In the former case, for example, while the vehicle 1 is traveling, the front of the vehicle 1 can be captured by the camera 211, and the haze superimposed image can be generated while sensing the front of the vehicle 1 by the millimeter wave radar 212.

Meanwhile, in the latter case, for example, the captured image captured by the camera 211 and the millimeter wave data generated by the millimeter wave radar 212 are temporarily accumulated, and then the haze superimposed image is generated on the basis of the accumulated captured image and the millimeter wave data. The method of generating the haze superimposed image can also be applied to a case where the information processing section 213 is provided in the vehicle 1.

<Haze Superimposed Image Generation Processing>

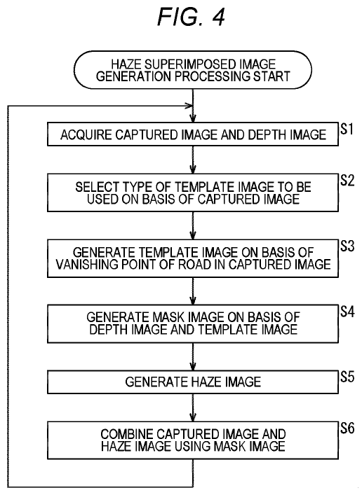

Next, haze superimposed image generation processing executed by the information processing system 201 will be described with reference to a flowchart of FIG. 4.

Note that, hereinafter, processing in a case where while the vehicle 1 is traveling, the front of the vehicle 1 is captured by the camera 211, and the haze superimposed image is generated while sensing the front of the vehicle 1 by the millimeter wave radar 212 will be described.

This processing is started, for example, when an operation for starting the vehicle 1 and starting driving is performed, for example, when an ignition switch, a power switch, a start switch, or the like of the vehicle 1 is turned on. Furthermore, this process ends, for example, when an operation for ending driving of the vehicle 1 is performed, for example, when an ignition switch, a power switch, a start switch, or the like of the vehicle 1 is turned off.

In step S1, the information processing section 213 acquires the captured image and the depth image.

Specifically, the camera 211 captures the front of the vehicle 1 and supplies the obtained captured image to the image processing section 221. The image processing section 221 performs predetermined image processing on the captured image, and supplies the captured image after the image processing to the template image generation section 222 and the combining section 227.

The millimeter wave radar 212 performs sensing in front of the vehicle 1 and supplies the obtained millimeter wave data to the signal processing section 223. The signal processing section 223 performs predetermined signal processing on the millimeter wave data to generate a sensing image that is an image indicating a sensing result of the millimeter wave radar 212. The depth image generation section 224 performs geometric conversion of the sensing image and converts the sensing image into an image in the same coordinate system as the captured image, thereby generating a depth image. Furthermore, the depth image generation section 224 adjusts the number of pixels of the sensing image to the number of pixels (size) of the captured image after the image processing by performing pixel interpolation or the like. The depth image generation section 224 supplies the depth image to the weight setting section 225.

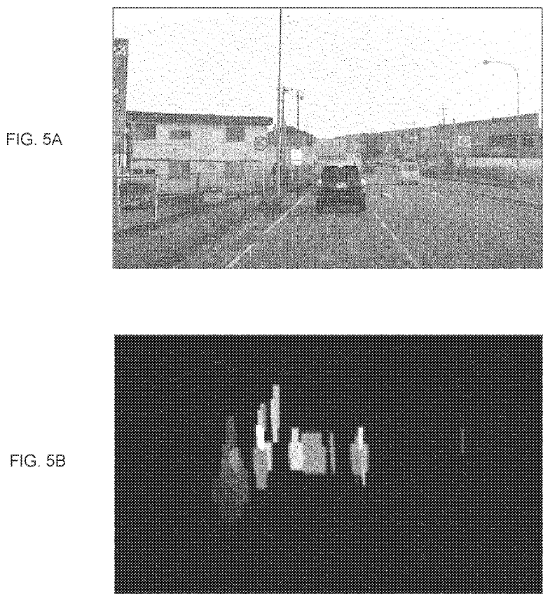

FIG. 5 illustrates an example of the captured image and the depth image acquired at substantially the same timing. A of FIG. 5 schematically illustrates an example of the captured image. B of FIG. 5 schematically illustrates an example of the depth image.

The depth value (pixel value) of each pixel of the depth image is represented by, for example, 256 gradations of gray scale from 0 (black) to 255 (white). The depth value increases (brightens) as the strength of the light reception signal in each pixel increases, and the depth value decreases (darkens) as the strength of the light reception signal in each pixel decreases.

In step S2, the template image generation section 222 acquires the type of the template image to be used on the basis of the captured image. Specifically, the template image generation section 222 recognizes a region in which the sky is captured in the captured image. The template image generation section 222 selects a template image to be used on the basis of the sky area (the number of pixels) in the captured image. For example, the template image generation section 222 selects the type of the template image to be used by comparing the ratio of the area occupied by the sky in the captured image with a predetermined threshold value.

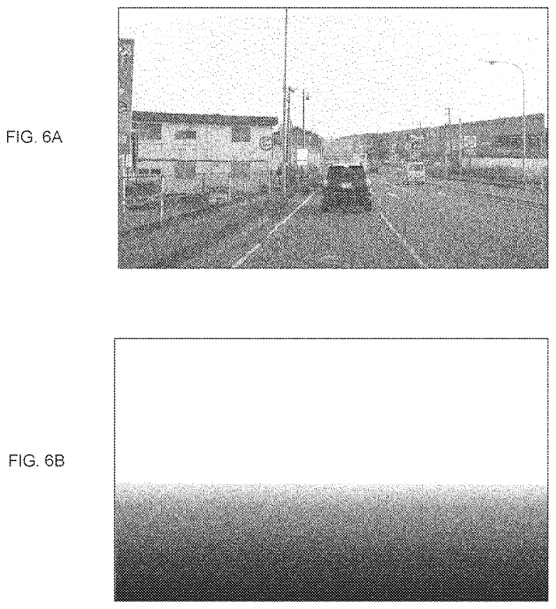

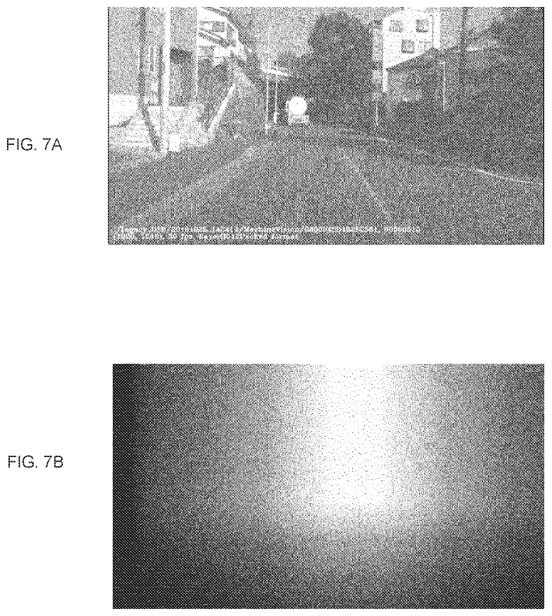

FIGS. 6 and 7 illustrate examples of types of template images.

FIG. 6 illustrates an example of a template image selected in a case where the ratio of the area occupied by the sky in the captured image is equal to or larger than a predetermined threshold value. Specifically, A of FIG. 6 illustrates the same captured image as A of FIG. 5. B of FIG. 6 schematically illustrates an example of a template image selected for the captured image in A of FIG. 6.

This captured image is an image captured while the vehicle is traveling on a flat road with a good view, and an upper sky portion of the captured image is wide, and the left and right sides are not blocked by a building or the like. In this case, the template image of the pattern illustrated in B of FIG. 6 is selected.

FIG. 7 illustrates an example of a template image selected in a case where the ratio of the area occupied by the sky in the captured image is less than the predetermined threshold value. Specifically, A of FIG. 7 schematically illustrates an example of the captured image. B of FIG. 7 schematically illustrates an example of a template image selected for the captured image in A of FIG. 7.

This captured image is an image captured while the vehicle is traveling on an ascending slope, the position of the road surface in the image is higher than the captured image in A of FIG. 6, and the sky area is accordingly smaller. Moreover, buildings, trees, and the like are densely located on the left and right sides of the road, and the sky is blocked. In this case, the template image of the pattern illustrated in B of FIG. 7 is selected.

Note that these template images are images having the same number of pixels (size) as the captured image after the image processing. Furthermore, the pixel value of each pixel of these template images is represented by, for example, 256 gradations of gray scale from 0 (black) to 255 (white), similarly to the depth image.

In this manner, template images of different patterns are selected on the basis of the sky area in the captured image. Note that details of the pattern of each template image will be described later.

In step S3, the template image generation section 222 generates a template image on the basis of a vanishing point of a road in the captured image. Specifically, the template image generation section 222 recognizes a road in the captured image and further recognizes a vanishing point of the road. Then, the template image generation section 222 generates a template image on the basis of the recognized vanishing point.

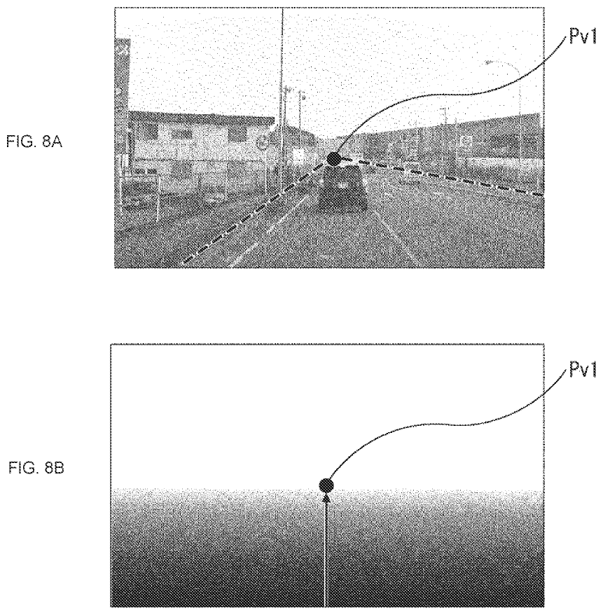

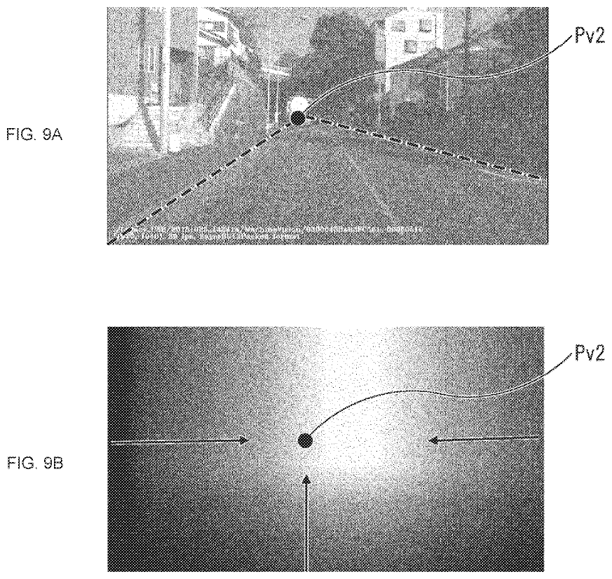

Here, an example of a method of generating a template image will be described with reference to FIGS. 8 and 9.

A of FIG. 8 is the same captured image as A of FIG. 6, and a vanishing point Pv1 indicates a vanishing point of a road in the captured image. Then, as illustrated in B of FIG. 8, a pattern is generated with reference to the vanishing point Pv1.

Specifically, in the region below the vanishing point Pv1 of the template image, a pattern that becomes gradually thinner toward the row in the horizontal direction where the vanishing point Pv2 exists is generated. Specifically, in the region below the vanishing point Pv2, the gradation pattern in which the color of the pixels at the lower end of the template image is darkest, the color of the pixels in the row where the vanishing point Pv2 exists is lightest, and the color density changes substantially uniformly in the vertical direction is generated. Meanwhile, in the region above the vanishing point Pv1, the pixel values of all the pixels are set to 255 (white).

A of FIG. 9 is the same captured image as A of FIG. 7, and a vanishing point Pv2 indicates a vanishing point of a road in the captured image. Then, as illustrated in B of FIG. 9, a pattern is generated with reference to the vanishing point Pv2.

Specifically, in the region below the vanishing point Pv2 of the template image, similarly to the region below the vanishing point Pv1 of the template image in B of FIG. 8, a pattern that becomes gradually thinner toward the row in the horizontal direction where the vanishing point Pv2 exists is generated.

Furthermore, in the region on the left side of the vanishing point Pv2 of the template image, a pattern that becomes gradually thinner toward the column in the vertical direction where the vanishing point Pv2 exists is generated. Specifically, in the region on the left side of the vanishing point Pv2, the gradation pattern in which the color of the pixels at the left end of the template image becomes the darkest, the color of the pixels in the column where the vanishing point Pv2 exists becomes the lightest, and the color density changes substantially uniformly in the left-right direction is generated.

Moreover, in the region on the right side of the vanishing point Pv2 of the template image, a pattern that becomes gradually thinner toward the column in the vertical direction where the vanishing point Pv2 exists is generated. Specifically, in the region on the right side of the vanishing point Pv2, the gradation pattern in which the color of the pixels at the right end of the template image becomes the darkest, the color of the pixels in the column where the vanishing point Pv2 exists becomes the lightest, and the color density changes substantially uniformly in the left-right direction is generated.

Note that, in the region below and on the left side of the vanishing point Pv2, a pattern below the vanishing point Pv2 and a pattern on the left side of the vanishing point Pv2 are superimposed. Furthermore, in the region below and on the right side of the vanishing point Pv2, a pattern below the vanishing point Pv2 and a pattern on the right side of the vanishing point Pv2 are superimposed.

Here, haze is formed by collecting water vapor or fine particles. Therefore, as the distance to the object in front increases, the amount of water vapor or fine particles between the vehicle 1 and the object in front increases, so that the density of the haze viewed from the vehicle 1 increases. Meanwhile, the density of the haze viewed from the vehicle 1 decreases as the distance to the object in front decreases, because the amount of water vapor or fine particles between the vehicle 1 and the object in front decreases. However, since the distribution of the water vapor or the fine particles is not necessarily uniform and the water vapor or the fine particles move, the density of the haze does not become uniform even for an object at the same distance, and constantly changes both spatially and temporally.

Therefore, in order to reproduce the haze closer to nature, the distribution of the shading of the pattern is adjusted to appropriately vary in the template images of B of FIGS. 8 and B of FIG. 9. For example, after the template image in which the shading of the pattern is uniformly changed by the above-described condition is generated, the pixels are appropriately replaced or the pixel values are increased or decreased using a random number or the like.

Furthermore, for example, the shading of each pixel of the template image is adjusted so as to appropriately vary between frames. For example, the color density is adjusted so as not to be constant between frames in the same pixel of the template image using a random number or the like.

As a result, a more natural haze is reproduced.

The template image generation section 222 supplies the generated template image to the weight setting section 225.

In step S4, the weight setting section 225 generates a mask image on the basis of the depth image and the template image.

Specifically, first, the weight setting section 225 generates a combined depth image by combining the depth image and the template image. For example, the weight setting section 225 generates a combined depth image in which an average of the depth value (pixel value) of each pixel of the depth image and the pixel value of the pixel at the same position of the template image is set as the depth value of each pixel.

Furthermore, the weight setting section 225 performs scale conversion of the depth value of the combined depth image as necessary. For example, the weight setting section 225 performs scale conversion of the depth value range of the combined depth image from the range of 0 to 255 to the range of 185 to 255. As a result, depth values of pixels having small depth values among the pixels of the combined depth image are raised. As a result, in particular, in the pixels of the captured image corresponding to the pixels having the small depth values, the haze to be superimposed becomes thick.

Note that, for example, the range of the depth value after scale conversion is adjusted on the basis of the density of the haze to be superimposed on the captured image. For example, as the haze to be superimposed on the captured image becomes thicker, the range of the depth value after scale conversion is narrowed, and the minimum value of the depth value is increased. Meanwhile, as the haze to be superimposed on the captured image becomes thinner, the range of the depth value after scale conversion is widened, and the minimum value of the depth value is decreased.

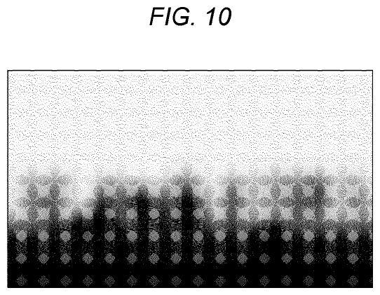

FIG. 10 schematically illustrates an example of a combined depth image obtained by combining the depth image of B of FIG. 5 and the template image of B of FIG. 8.

For example, on a road surface in front of the vehicle 1, the transmission signal is less likely to be reflected in the direction of the vehicle 1. Therefore, for example, as in the depth image in B of FIG. 5, the difference between the depth value for the road surface present near the vehicle 1 and the depth value for the sky present far from the vehicle 1 becomes small.

On the other hand, by combining the depth image and the template image, the depth value of each pixel of the depth image before combining is corrected by the pixel value of each pixel of the template image. For example, as illustrated in the combined depth image of FIG. 10, the difference between the depth value of the region corresponding to the road surface and the depth value of the region corresponding to the sky can be widened. As a result, the difference between the density of the haze superimposed on the region of the road surface and the density of the haze superimposed on the region of the sky is brought close to a state close to nature.

Next, the weight setting section 225 calculates the weight w (x) of the pixel position x of the mask image on the basis of the depth value d (x) of the pixel position x of the corrected depth image by the following equation (1).

w(x)=e^{-βd(x)} (1)

Note that β is a constant.

Since the depth value d (x) is an integer of 0 or more, the weight w (x) is within a range of 0 to 1. Furthermore, the weight w (x) decreases as the depth value d (x) increases, and increases as the depth value d (x) decreases.

The weight setting section 225 supplies the mask image in which the pixel value of each pixel is the weight w (x) to the combining section 227.

In step S5, the haze image generation section 226 generates a haze image. Specifically, the haze image generation section 226 generates a haze image that represents a virtual haze to be superimposed on the captured image and has the same number of pixels (size) as the captured image. For example, the haze image is an image having a texture similar to that of the superimposed haze and representing a substantially uniform pattern.

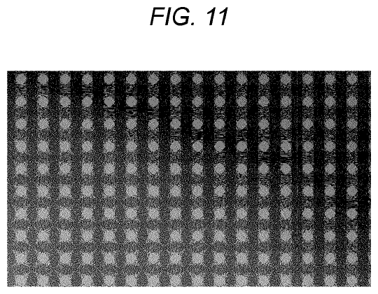

For example, in a case where the type of haze to be superimposed is fog, an image including solid noise is generated as a haze image as schematically illustrated in FIG. 11.

Note that the density of the haze image is adjusted on the basis of the density of the haze superimposed on the captured image. For example, the thicker the haze superimposed on the captured image, the darker the haze image, and the thinner the haze superimposed on the captured image, the thinner the haze image.

Furthermore, for example, the color density of each pixel of the haze image is adjusted so as to appropriately vary between frames. For example, in the same pixel of the haze image, the color density is adjusted so as not to be constant between frames.

In step S6, the combining section 227 combines the captured image and the haze image using the mask image. Specifically, the combining section 227 calculates the pixel value I (x) of the pixel position x of the haze superimposed image by performing weighted addition on the pixel value J (x) of the pixel position x of the captured image and the pixel value A (x) of the pixel position x of the haze image by using the weight w (x) of the pixel position x of the mask image according to the following equation (2).

I(x)=J(x)·w(x)+A(x)·(1−w(x)) (2)

Therefore, in the pixel value I (x) of the haze superimposed image, as the weight w (x) increases, the component of the pixel value J (x) of the captured image increases, and the component of the pixel value A (x) of the haze image decreases. Here, since the weight w (x) increases as the depth value d (x) of the combined depth image decreases, the component of the pixel value J (x) increases and the component of the pixel value A (x) decreases as the depth value d (x) decreases. That is, for example, the haze superimposed on the captured image becomes thinner in a region where an object exists closer to the vehicle 1.

Meanwhile, in the pixel value I (x) of the haze superimposed image, as the weight w (x) decreases, the component of the pixel value J (x) of the captured image decreases, and the component of the pixel value A (x) of the haze image increases. Here, since the weight w (x) decreases as the depth value d (x) of the combined depth image increases, the component of the pixel value J (x) decreases and the component of the pixel value A (x) increases as the depth value d (x) increases. That is, the haze superimposed on the captured image becomes thicker in a region where an object exists farther from the vehicle 1 or in a region where no object exists in front of the vehicle 1.

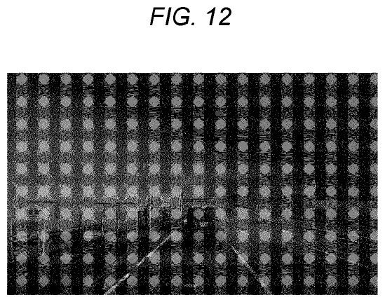

FIG. 12 schematically illustrates an example of a haze superimposed image in which the haze image representing the virtual fog of FIG. 11 is superimposed on the captured image of A of FIG. 5.

In this haze superimposed image, for example, the fog becomes lighter in a lower region (for example, the region of the road surface) of the image closer to the vehicle 1, and the fog becomes darker in an upper region (for example, the region of the sky) of the image farther from the vehicle 1.

Furthermore, the fog is thin in a region where an object existing at a position close to the vehicle 1, such as a vehicle in front, is present. In this way, it is possible to reproduce a fog close to nature.

The combining section 227 outputs the generated haze superimposed image to the subsequent stage. For example, the combining section 227 causes the recording section 28 to record the haze superimposed image.

Thereafter, the processing returns to step S1, and the processing of steps S1 to S6 is repeatedly executed.

As described above, the haze superimposed image in which the virtual haze is superimposed on the captured image can be easily generated without performing complicated processing.

Furthermore, since the density of the superimposed haze is adjusted on the basis of the depth value for the pixel of each captured image, a natural haze can be reproduced. Moreover, by correcting the depth value of the depth image using the template image, a more natural haze can be reproduced.

Moreover, by adjusting at least one of the color density of each pixel in the template image or the color density of each pixel in the haze image to appropriately vary, a more natural haze can be reproduced.

Furthermore, at least one of the color density of each pixel of the template image or the color density of each pixel of the haze image is adjusted to appropriately vary between frames, so that the pattern of the haze superimposed between the frames naturally changes. As a result, for example, occurrence of over-learning in machine learning using the haze superimposed image is prevented. Specifically, for example, in a case where the haze of the same pattern is superimposed on each frame, there is a possibility that over-learning in which object recognition is performed on the basis of the superimposed haze pattern occurs. On the other hand, since the pattern of the haze superimposed between frames naturally changes, such over-learning is prevented from occurring.

Moreover, by adjusting at least one of the density of the template image, the density of the haze image, or the range of the depth value after scale conversion of the combined depth image, the density of the haze to be superimposed can be easily adjusted.

### 3. MODIFICATIONS

Hereinafter, modifications of the above-described embodiments of the present technology will be described.

For example, it is possible to increase or change the type of the template image.

For example, the method of generating the depth image is not limited to the above-described method, and any method can be used. For example, it is possible to generate a depth image using a sensor capable of detecting depth other than the millimeter wave radar 212. As such a sensor, for example, LiDAR, an ultrasonic sensor, a stereo camera, a depth camera, or the like is assumed. Furthermore, the depth image may be generated by combining a plurality of types of sensors.

Note that, in a case where it is possible to directly detect the depth for each pixel of the captured image without performing geometric conversion or the like using a stereo camera, a depth camera, or the like, for example, it is also possible to generate the mask image using only the depth image without using the template image.

For example, the present technology can be used in a case of generating a learning image of a recognition model that performs object recognition in a direction other than the front of the vehicle 1. Furthermore, the present technology can be used in a case of generating a learning image of a recognition model that performs object recognition around a moving body moving outdoors other than a vehicle. As such a moving body, for example, a motorcycle, a bicycle, a personal mobility, an airplane, a ship, a drone, a robot, and the like are assumed.

### 4. OTHERS

<Configuration Example of Computer>

The above-described series of processing can be executed by hardware or software. In a case where the series of processing is executed by software, a program constituting the software is installed in a computer. Here, the computer includes a computer incorporated in dedicated hardware, a general-purpose personal computer capable of executing various functions by installing various programs, and the like, for example.

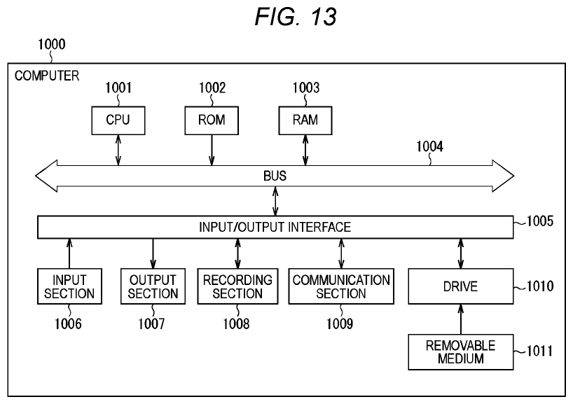

FIG. 13 is a block diagram illustrating a configuration example of hardware of a computer that executes the above-described series of processing by a program.

In a computer 1000, a central processing unit (CPU) 1001, a read only memory (ROM) 1002, and a random access memory (RAM) 1003 are mutually connected by a bus 1004.

An input/output interface 1005 is further connected to the bus 1004. An input section 1006, an output section 1007, a recording section 1008, a communication section 1009, and a drive 1010 are connected to the input/output interface 1005.

The input section 1006 includes an input switch, a button, a microphone, an imaging element, and the like. The output section 1007 includes a display, a speaker, and the like. The recording section 1008 includes a hard disk, a nonvolatile memory, and the like. The communication section 1009 includes a network interface and the like. The drive 1010 drives a removable medium 1011 such as a magnetic disk, an optical disk, a magneto-optical disk, or a semiconductor memory.

In the computer 1000 configured as described above, for example, the CPU 1001 loads a program recorded in the recording section 1008 into the RAM 1003 via the input/output interface 1005 and the bus 1004 and executes the program, whereby the above-described series of processing is performed.

The program executed by the computer 1000 (CPU 1001) can be provided by being recorded in the removable medium 1011 as a package medium or the like, for example. Furthermore, the program can be provided via a wired or wireless transmission medium such as a local area network, the Internet, or digital satellite broadcasting.

In the computer 1000, the program can be installed in the recording section 1008 via the input/output interface 1005 by attaching the removable medium 1011 to the drive 1010. Furthermore, the program can be received by the communication section 1009 via a wired or wireless transmission medium and installed in the recording section 1008. In addition, the program can be installed in the ROM 1002 or the recording section 1008 in advance.

Note that the program executed by the computer may be a program in which processing is performed in time series in the order described in the present specification, or may be a program in which processing is performed in parallel or at necessary timing such as when a call is made or the like.

Furthermore, in the present specification, a system means a set of a plurality of components (devices, modules (parts), or the like), and it does not matter whether or not all the components are in the same housing. Therefore, a plurality of devices housed in separate housings and connected via a network and one device in which a plurality of modules is housed in one housing are both systems.

Moreover, the embodiments of the present technology are not limited to the above-described embodiments, and various modifications can be made without departing from the gist of the present technology.

For example, the present technology can have a configuration of cloud computing in which one function is shared and processed in cooperation by a plurality of devices via a network.

Furthermore, each step described in the above-described flowcharts can be executed by one device or can be shared and executed by a plurality of devices.

Moreover, in a case where a plurality of processes is included in one step, the plurality of processes included in the one step can be executed by one device or can be shared and executed by a plurality of devices.

### COMBINATION EXAMPLE OF CONFIGURATION

The present technology can also have the following configurations.

(1)

An information processing apparatus including
a combining section that performs weighted addition of a pixel of a captured image and a pixel of a haze image representing a virtual haze by using a weight based on a depth value for each pixel of the captured image.

(2)

The information processing apparatus according to (1), further including
a weight setting section that sets the weight for each pixel of the captured image on the basis of the depth value for each pixel of the captured image.

(3)

The information processing apparatus according to (2), further including
a template image generation section that generates a template image representing a pattern corresponding to shading of haze,
in which the weight setting section sets the weight for each pixel of the captured image on the basis of the depth value of each pixel of a second depth image obtained by combining a first depth image and the template image in a same coordinate system as the captured image.

(4)

The information processing apparatus according to (3),
in which the template image generation section sets a region in which the pattern is generated in the template image with reference to a vanishing point of a road in the captured image.

(5)

The information processing apparatus according to (4),
in which the template image generation section selects a type of the template image on the basis of an area of sky in the captured image, and sets a region in which the pattern is generated and a direction in which shading of the pattern is changed in the template image on the basis of the type of the template image and the vanishing point.

(6)

The information processing apparatus according to (5),
in which the type of the template image includes a first template image in which the pattern becomes thinner as going upward in a region below the vanishing point, and a second template image in which the pattern becomes thinner as going upward in a region below the vanishing point, the pattern becomes thinner as going rightward in a region on a left side of the vanishing point, and the pattern becomes thinner as going leftward in a region on a right side of the vanishing point.

(7)

The information processing apparatus according to any one of (4) to (6),
in which the template image generation section makes the pattern thinner toward a column or a row in which the vanishing point exists in a region in which the pattern is generated.

(8)

The information processing apparatus according to any one of (3) to (7),
in which the template image generation section generates the template image for each frame of the captured image, and varies shading of a same pixel between frames of the template image.

(9)

The information processing apparatus according to any one of (3) to (8),
in which the template image generation section varies a distribution of shading of the pattern in the template image.

(10)

The information processing apparatus according to any one of (3) to (9),
in which the template image generation section adjusts a density of the pattern on the basis of a density of haze to be superimposed on the captured image.

(11)

The information processing apparatus according to any one of (3) to (10),
in which the weight setting section performs scale conversion of the depth value of the second depth image.

(12)

The information processing apparatus according to (11),
in which the weight setting section adjusts a range of the depth value of the second depth image after the scale conversion on the basis of a density of haze to be superimposed on the captured image.

(13)

The information processing apparatus according to any one of (3) to (12),
in which the first depth image is an image obtained by converting a sensing image indicating a sensing result of a sensor capable of detecting depth into a same coordinate system as the captured image.

(14)

The information processing apparatus according to any one of (2) to (13),
in which the weight setting section decreases the weight as the depth value increases.

(15)

The information processing apparatus according to any one of (1) to (14), further including
a haze image generation section that generates the haze image.

(16)

The information processing apparatus according to (15),
in which the haze image generation section adjusts a density of the haze image on the basis of a density of haze to be superimposed on the captured image.

(17)

The information processing apparatus according to (15) or (16),
in which the haze image generation section generates the haze image for each frame of the captured image, and causes shading of a same pixel to vary between frames of the haze image.

(18)

The information processing apparatus according to any one of (15) to (17),
in which the haze image generation section generates an image having a texture similar to that of the haze and representing a substantially uniform pattern as the haze image.

(19)

An information processing method in which
an information processing apparatus performs
weighted addition of a pixel of a captured image and a pixel of a haze image representing a virtual haze by using a weight based on a depth value for each pixel of the captured image.

(20)

A program for causing a computer to execute processing of
weighted addition of a pixel of a captured image and a pixel of a haze image representing a virtual haze by using a weight based on a depth value for each pixel of the captured image.

Note that the effects described in the present specification are merely examples and are not limited, and other effects may be provided.

### REFERENCE SIGNS LIST

1 Vehicle
73 Recognition section
201 Information processing apparatus
211 Camera
212 Millimeter wave radar
221 Image processing section
222 Template image generation section
223 Signal processing section
224 Depth image generation section
225 Weight setting section
226 Haze image generation section
227 Combining section

1. An information processing apparatus comprising
a combining section that performs weighted addition of a pixel of a captured image and a pixel of a haze image representing a virtual haze by using a weight based on a depth value for each pixel of the captured image.

2. The information processing apparatus according to claim 1, further comprising
a weight setting section that sets the weight for each pixel of the captured image on a basis of the depth value for each pixel of the captured image.

3. The information processing apparatus according to claim 2, further comprising
a template image generation section that generates a template image representing a pattern corresponding to shading of haze,
wherein the weight setting section sets the weight for each pixel of the captured image on a basis of the depth value of each pixel of a second depth image obtained by combining a first depth image and the template image in a same coordinate system as the captured image.

4. The information processing apparatus according to claim 3,
wherein the template image generation section sets a region in which the pattern is generated in the template image with reference to a vanishing point of a road in the captured image.

5. The information processing apparatus according to claim 4,
wherein the template image generation section selects a type of the template image on a basis of an area of sky in the captured image, and sets a region in which the pattern is generated and a direction in which shading of the pattern is changed in the template image on a basis of the type of the template image and the vanishing point.

6. The information processing apparatus according to claim 5,
wherein the type of the template image includes a first template image in which the pattern becomes thinner as going upward in a region below the vanishing point, and a second template image in which the pattern becomes thinner as going upward in a region below the vanishing point, the pattern becomes thinner as going rightward in a region on a left side of the vanishing point, and the pattern becomes thinner as going leftward in a region on a right side of the vanishing point.

7. The information processing apparatus according to claim 4,
wherein the template image generation section makes the pattern thinner toward a column or a row in which the vanishing point exists in a region in which the pattern is generated.

8. The information processing apparatus according to claim 3,
wherein the template image generation section generates the template image for each frame of the captured image, and varies shading of a same pixel between frames of the template image.

9. The information processing apparatus according to claim 3,
wherein the template image generation section varies a distribution of shading of the pattern in the template image.

10. The information processing apparatus according to claim 3,
wherein the template image generation section adjusts a density of the pattern on a basis of a density of haze to be superimposed on the captured image.

11. The information processing apparatus according to claim 3,
wherein the weight setting section performs scale conversion of the depth value of the second depth image.

12. The information processing apparatus according to claim 11,
wherein the weight setting section adjusts a range of the depth value of the second depth image after the scale conversion on a basis of a density of haze to be superimposed on the captured image.

13. The information processing apparatus according to claim 3,
wherein the first depth image is an image obtained by converting a sensing image indicating a sensing result of a sensor capable of detecting depth into a same coordinate system as the captured image.

14. The information processing apparatus according to claim 2,
wherein the weight setting section decreases the weight as the depth value increases.

15. The information processing apparatus according to claim 1, further comprising
a haze image generation section that generates the haze image.

16. The information processing apparatus according to claim 15,
wherein the haze image generation section adjusts a density of the haze image on a basis of a density of haze to be superimposed on the captured image.

17. The information processing apparatus according to claim 15,
wherein the haze image generation section generates the haze image for each frame of the captured image, and causes shading of a same pixel to vary between frames of the haze image.

18. The information processing apparatus according to claim 15,
wherein the haze image generation section generates an image having a texture similar to that of the haze and representing a substantially uniform pattern as the haze image.

19. An information processing method in which
an information processing apparatus performs
weighted addition of a pixel of a captured image and a pixel of a haze image representing a virtual haze by using a weight based on a depth value for each pixel of the captured image.

20. A program for causing a computer to execute processing of
weighted addition of a pixel of a captured image and a pixel of a haze image representing a virtual haze by using a weight based on a depth value for each pixel of the captured image.
